(19) United States
(12) Patent Application Publication
(10) Pub. No.: US 2005/0154474 A1
(43) Pub. Date: Jul. 14, 2005

(54) Sensor element for vehicle bus system

(75) Inventors: Timo Kauntz, Tuebingen (DE); Carsten Lorenz, Sindelfingen (DE); Guido Villino, Leonberg (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/009,136

(22) Filed: Dec. 13, 2004

(30) Foreign Application Priority Data
Dec. 12, 2003 (DE) 103 58 106.5

(51) Int. Cl. G05B 15/00

(52) U.S. Cl. 700/1

(57) ABSTRACT

A sensor element for a bus system in a motor vehicle has a first number of pins by which it can be connected to the bus lines of the bus system, having differing potentials. The first number of pins is larger than the number of bus lines. A first device measures and evaluates the potential on at least one of the pins, while a second device assigns to the sensor element a specific address coding from the measured and evaluated potentials. The invention also relates to a bus system and to a method of operating the bus system.

### BACKGROUND AND SUMMARY OF THE INVENTION

This application claims the priority of German patent document 103 58 106.5, filed Dec. 12, 2003, the disclosure of which is expressly incorporated by reference herein.

The invention relates to a sensor element for vehicle busy system, as well as to a bus system and a method of operating the same.

Sensors and sensor elements in motor vehicles are generally known in a plurality of different embodiments and applications. Particularly in modern motor vehicles, these sensors are used, for example, for active or passive restraint systems in order to be able to offer a maximum amount of safety to the motor vehicle occupants. In restraint systems for active safety, acceleration sensors for the early recognition of a crash are situated at different positions in the motor vehicle.

In such systems, sensor elements with partially redundant effects are set up at several different positions in a motor vehicle. However, it is important that the exact position of the respective sensor elements in the motor vehicle be known also after their installation in the motor vehicle, so that a desired sensor element can be controlled in a targeted manner by the corresponding control unit. In particular, it is important to avoid a mix-up of the sensor elements provided for certain positions in the motor vehicle. This can be implemented, for example, by a different construction of the plugs of the sensor element or different housing constructions. The plugs or housings of the sensor elements have, for example, noses, rails, beads, etc., so that the plug or the corresponding sensor element fits only into the matching counterpart. Different colored markings are also conceivable so that a clear assignment of the respective sensor element to its predefined position in the motor vehicle becomes possible. However, the provision of differently designed sensor elements leads to higher manufacturing costs, higher storage costs and, because of the greater variety of parts, also to higher mounting costs.

Particularly for mounting-related reasons, but also for manufacturing-related reasons, it is advantageous for these sensor elements having the same effect to have a construction that is not only similar but, if possible, identical. These sensor elements can therefore be manufactured in very large piece numbers, which is more cost-effective in comparison to the manufacturing of a correspondingly smaller number of different sensor elements and is therefore preferable. Also for mounting-related reasons, this is advantageous since, during the mounting, it is no longer necessary to differentiate as to which sensor elements have to be installed at which position in the motor vehicle. As a result the mounting of the sensor elements can be implemented more rapidly, which is more cost-effective.

If similar sensor elements having the same effect are installed in the motor vehicle, their precise position must be known, so that the control element can correspondingly control these sensor elements. In addition, it is important that the control unit can assign the signals supplied by this particular sensor element also to a corresponding position of the sensor element in the motor vehicle.

When a plurality of identical sensor elements are used, they are coupled for this purpose to the bus lines of a peripheral bus system with external sensors, typically in a so-called daisy-chain configuration. The construction and the method of operation of such a daisy chain bus system is generally known, for example, from the paperback with the title Mikroprozessortechnik (Microprocessor Technology), edited by Thomas Beierlein, Olaf Hagenbruch, Fachbuchverlag (Technical Book Publishers) Leipzig, 1999, particularly on Page 211, and on. In contrast to the so-called party line configuration, in a daisy chain bus configuration the users (microprocessors, apparatuses, assemblies, sensors, etc.) connected to a bus are series-connected in a linked manner. The bus system has one or more masters which control the data communication; data transmitted by way of the bus line are virtually “passed through”. Thus, each user connected to the bus can transmit messages to any other user in this manner.

However, the use of a daisy chain bus system is cost-intensive and, in addition, the data transmission rate is significantly reduced because of the successively arranged bus users which in each case forward the data to be transmitted. Also, the daisy chain bus configuration is not suitable for special bus systems, such as a LIN bus system (LIN—Local Interconnect Network).

The use of separately labeled (and different) sensor elements, as well as the use of identical sensor elements (having the same effect) in the so-called daisy chain operation is therefore only conditionally suitable.

In German Patent Document DE 101 21 786 A1, a sensor system for a motor vehicle is described in which structurally identical sensor elements having the same effect are provided on at least two different installation sites in a motor vehicle. A respective sensor element here has several different fastening points fastening the sensor element to the motor vehicle. Each of sensor elements at the various positions in the motor vehicle is fastened to a different fastening point of the sensor element. Thus, at various fastening points of the sensor elements, different potential conditions occur which are typical of a respective sensor element. A sensor element can be identified on the basis of these typical potential conditions.

One object of the present invention is to provide an improved technique for clearly identifying the position of several identical sensor elements in a motor vehicle. In particular, a simpler arrangement, which is as cost-effective as possible, is to be provided for using a plurality of sensor elements having the same effect in a motor vehicle.

This and other objects and advantages are achieved by the sensor element and bus system according to the invention in which binary information is obtained by providing the sensor with a larger number of output connections than would normally be required for contacting with the bus lines. As a result of the larger number of output connections, virtually redundant output connections can be implemented, which can be utilized for providing additional information. Binary information can then be obtained particularly from the manner in which the output connections are connected with the bus lines. The number of sensor elements to be installed in the motor vehicle determines whether more or less redundancy needs be derived. The redundancy therefore has to be selected such that a binary address coding is provided by which an address specific to a respective sensor element can be assigned. Depending on the type of the binary address coding, more or fewer pins need be provided.

By means of this binary information, each of the sensor elements can be clearly identified. Once a sensor element has been clearly identified, a conclusion can be drawn at which point or in which position within the motor vehicle this sensor element is installed. Thus, if sensor signals with the corresponding coding are sent from this sensor element to a central control unit, the control unit first decodes the address coding and clearly assigns these sensor signals to a special sensor element and thus to its position in the motor vehicle. Subsequently, the control unit can initiate the corresponding measures.

The invention is therefore particularly suitable for sensor elements which have an identical construction, and thus the same design and the same effect. This is particularly advantageous for manufacturing-related reasons and also for mounting-related reasons.

Other objects, advantages and novel features of the present invention will become apparent from the following detailed description of the invention when considered in conjunction with the accompanying drawings.

### BRIEF DESCRIPTION OF THE DRAWINGS

In the following, the invention will be explained in detail by means of the embodiments indicated in the schematic figures of the drawing.

FIG. 1 is a block diagram of a first embodiment of a bus system according to the invention;

FIG. 2 is a circuit diagram of a first sensor element according to the invention for use in a bus system corresponding to FIG. 1;

FIG. 3 is a block diagram of a second embodiment of a bus system according to the invention;

FIG. 4 is a circuit diagram of a second embodiment according to the invention for use in a bus system corresponding to FIG. 3;

FIG. 5 is a representation of various sensor elements in a bus system, by means of whose screwed connection, the position of these sensor elements in the motor vehicle is illustrated.

### DETAILED DESCRIPTION OF THE DRAWINGS

In all figures of the drawing, the same or functionally identical elements and signals—unless indicated otherwise—were provided with the same reference symbols.

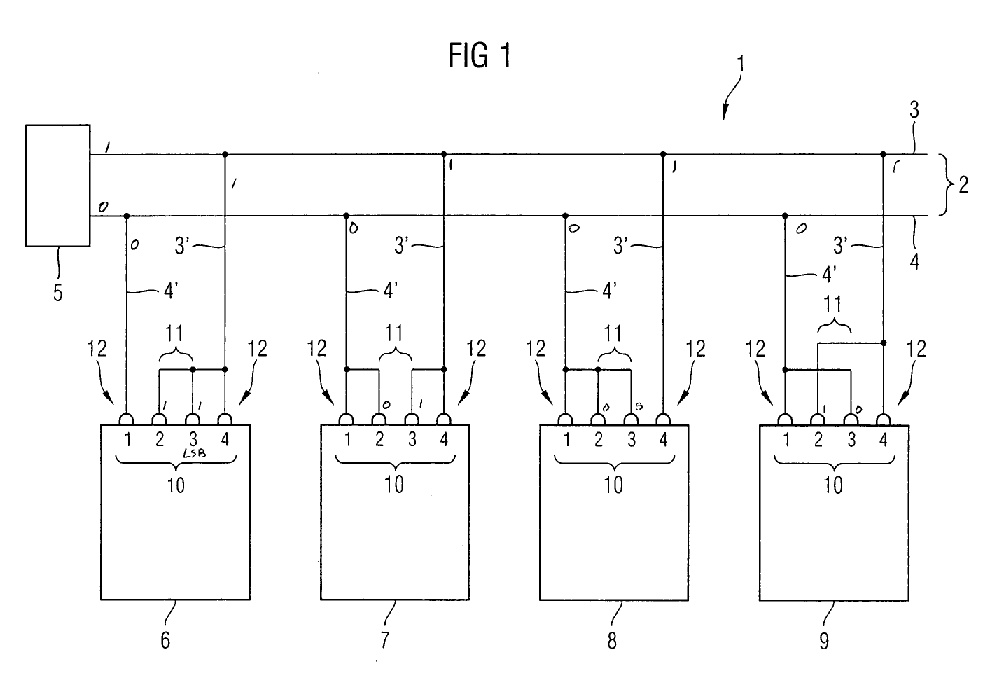

FIG. 1 is a block diagram of a first embodiment of a bus system 1 according to the invention (in this instance, for a restraint system, particularly an air bag system), in which an identification of the sensor elements takes place by a different pin assignment. The bus system 1 has a bus 2 with two bus lines 3, 4. The bus 2 may, for example, be a LIN bus or a CAN bus (CAN—Controller Area Network). (The construction and the method of operation of such LIN bus systems or CAN bus systems are generally known, and are not discussed in detail.) In a CAN bus system or of a LIN bus system, one bus line 3 in each case has a high logic level (HIGH, “1”) and the respective other bus line 4 has a low logic level (LOW, “0”).

The two bus lines 3, 4 of the bus 2 are connected with a control unit 5 typically operating as the master. In the present embodiment, this is an air bag control system.

The bus system 1 also has a plurality (in the present embodiment, four) sensor elements 6 to 9. It is assumed here that all sensor elements 6 to 9 have an identical construction; that is, that they are structurally the same, and of an identical method of operation. Each of the sensor elements 6 to 9 is connected by way of two connection lines 3′, 4′ respectively with the two bus lines 3, 4, so that bidirectional data communication can take place between the air bag control unit 5 and the sensor elements 6 to 9.

For coupling to a two-wire bus 2, each sensor element 6 to 9 must have two pins. In contrast, however, the sensor elements 6 to 9 according to the invention have more than two pins 10—in the present embodiment, four pins. That is, two pins more than would be required for coupling a sensor element 6 to 9 to the two bus lines 3, 4. In a way, a redundancy in the number of pins 10 is provided for each sensor element 6 to 9, by way of which information can be obtained for the identification of the respective sensor element 6 to 9 as to at which point in the vehicle a respective sensor element 6 to 9 is installed or fastened. This information is contained in the different assignment of these pins 10.

As illustrated in FIG. 1, two pins 12, (in the present embodiment, the first and fourth contact output pin) of each respective sensor element 6 to 9 are connected with the same bus lines 3, 4 in each case. That is, the first output pin in all of the sensor elements 6 to 9 is connected with the bus line 4, and the fourth output pin in all of sensor elements 6 to 9 is connected with the bus line 3. In the following, these pins are called fixedly assigned output pins 12.

On the other hand, the two other pins 11 of each respective sensor element 6 to 9 are not fixedly defined and, in the following, will therefore be called variably assignable pins 11. In all of the sensor elements 6 to 9, these variably assignable pins 11 are wired differently relative to the coupling to the bus lines 3, 4. In the present embodiment, the variably assignable pins 11 in the case of sensor element 6 are connected only with the bus line 3, and in the case of sensor element 8 they are connected only with the bus line 4. In the case of sensor element 7, one of the variably assignable pins 11 (second pin) is connected with the bus line 4, and the second of the variably assignable pins 11 (third pin) is connected with the bus line 3. In sensor element 9, these variably assignable pins 11 are connected in an inverse manner in comparison to sensor element 7.

Thus, to an extent, this results in a coding for these variably assignable pins 11 which—as will be described in detail in the following—can also be measured and decoded. Therefore, let it be assumed that, for example, a logic “1” is assigned to the variably assignable pins 11 that are connected with the bus line 3 having a high logic level, and that a logic “0” is assigned to the variably assignable pins 11 that are connected with the bus line 4 having a low logic level. Thus, an address coding, which is different in the case of all sensor elements 6 to 9, is assigned to each sensor element 6 to 9 by way of the variably assignable pins 11, which address coding is as follows in FIG. 1:
Sensor element 6: 11
sensor element 7: 01
sensor element 8: 00
sensor element 9: 10
   In this case, the third pin indicates the LSB bit of the 2-bit address code.

Each sensor element 6 to 9 therefore has a different access code. The information contained in the variably assignable pins 11 concerning their coupling to the bus lines 3,4 can therefore be used for the addressing of the different sensor elements 6 to 9.

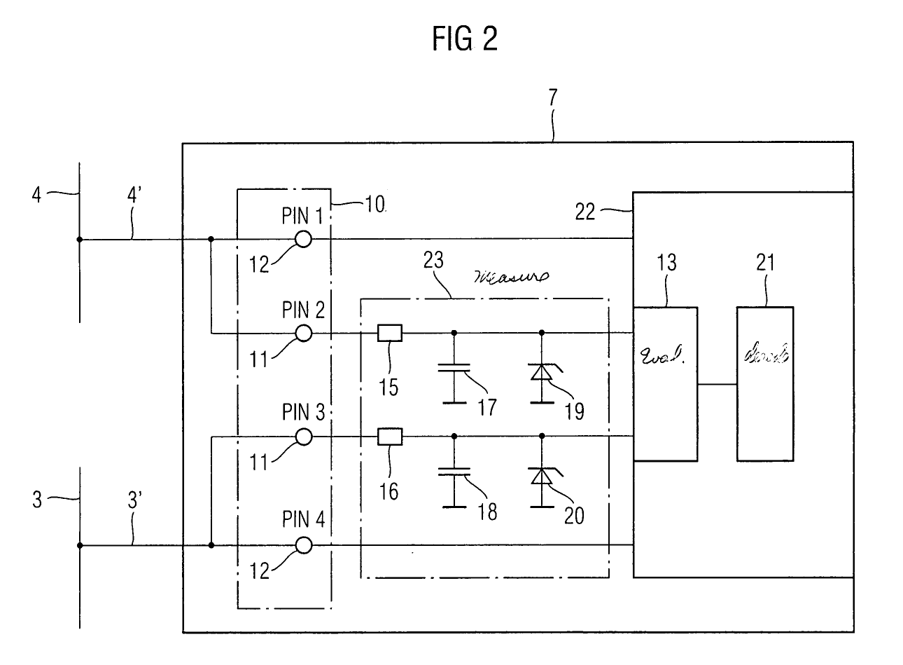

FIG. 2 is a wiring diagram of a sensor element according to the invention for use in a bus system such as depicted in FIG. 1. On the basis of the assignment of the pins 11, 12, this figure corresponds to the sensor element 7 from FIG. 1.

For decoding the address information coupled in by way of the variably assignable pins 11, the sensor element 7 has a measuring circuit 23, an evaluating circuit 13 as well as a decoding circuit 21. By means of the measuring circuit 23, the potentials are measured which are applied to the variably assignable pins 11. For this purpose, each of the variably assignable pins 11 is equipped with a low-pass arrangement consisting of one resistor 15, 16 and one capacitor 17, 18 respectively, to which a Zener diode 19, 20 is connected on the output side for limiting the voltage of the measures potentials. The potentials measured by the measuring circuit 23 are fed to an evaluating circuit 13 connected to the output side of the measuring circuit 23, which evaluating circuit 13 assigns a logic level to a respectively measured potential. A decoder 21 connected on the output side of the evaluating circuit 13 determines the respective address code of the sensor element 7 from the logic level determined in the evaluating circuit 13.

In this manner, an address which is specific to each sensor element 6 to 9 can correspondingly also be assigned. In the case of a data communication of a sensor element 6 to 9 with the control unit 5, for example, this address is then transmitted together with the corresponding sensor signals sensed by the sensor element 6 to 9. The control unit 5 can then assign the sensor signals to the respective sensor element 6 to 9 and thus to its precise position in the motor vehicle.

Sensor element 7 also has a sensor circuit 22 which has the actual sensor as well as the corresponding bus interface. In the case of a sensor element for an air bag system, the sensor element 7 is designed as an acceleration sensor or speed sensor and is used for sensing an acceleration or speed in the event of an accident. In this example, the signals generated by the sensor 22 are derived from the sensed acceleration or speed and are transmitted by way of fixedly defined pins 12 and the bus lines 3, 4 to the control unit.

In the present embodiment, the evaluating circuit 13 and the decoder 21 are components of the sensor circuit 22 constructed as a user-specific integrated circuit (ASIC).

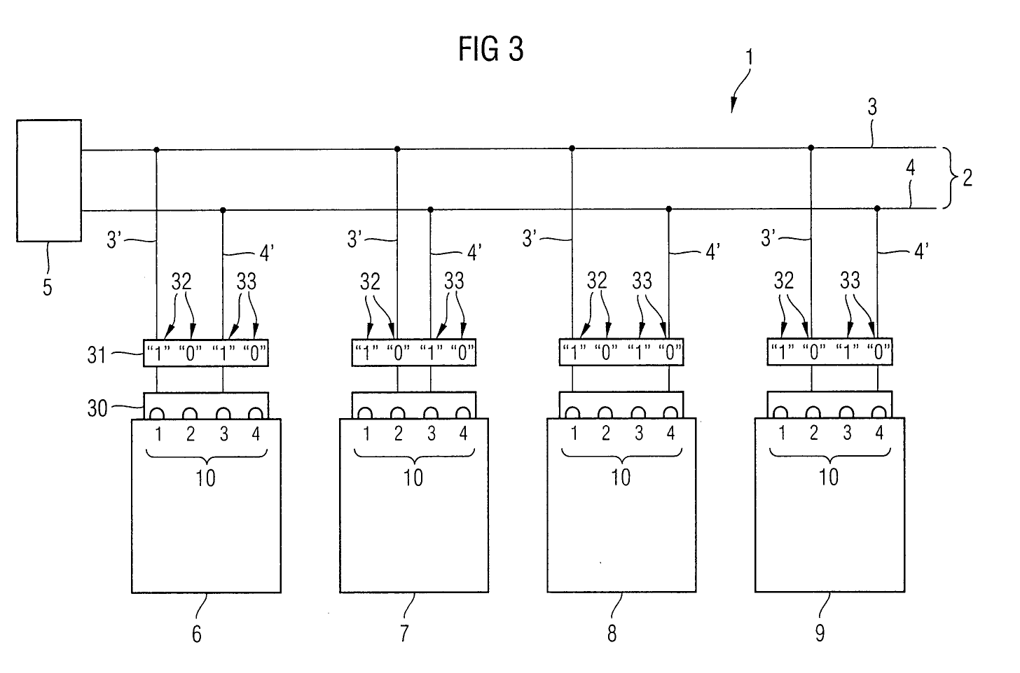

FIG. 3 is a block diagram of a second embodiment of a bus system according to the invention.

As in FIG. 1, the sensor elements 6 to 9 of the bus system 1 in FIG. 3 have a larger number of pins 10 than would be required on the basis of the number of bus lines 3, 4. Here also, all sensor elements 6 to 9 have an identical construction. Each sensor element 6 to 9 also has a plug 30 as an external hardware interface, which plug 30 contains the pins 10. In addition, by way of connection lines 3′, 4′ and one jack 31 respectively, the bus 2 is connected with each sensor element 6, 9 or its plug 30. In contrast to the embodiment of FIG. 1, however, in FIG. 3, not all pins 10 are connected with the bus lines 3, 4. Although, similar to FIG. 1, in each sensor element 6 to 9, respective other pins 10 are connected with the bus lines 3, 4.

The pins 10 are divided here into first pins 32, which are connected only with bus line 3, and second pins 33, which are connected only with bus line 4. First and second pins 32, 33 consist of two pins respectively. In each case, a logic “1” is assigned to one of the pins 32, 33, and a logic “0” is assigned to the other pin (see jack 31). In this manner, a binary address coding of the respective sensor element 6 to 9 can be achieved by the assignment of the first and second pins 32, 33 to the bus lines 3, 4, the first pins 32 and the second pins 33 each indicating different bits of the resulting 2-bit address coding. In the event that the pins 33 indicate the LSB bit (LSB=least significant bit), the following address coding is obtained for the sensor elements 6 to 9:
Sensor element 6: 11
sensor element 7: 01
sensor element 8: 10
sensor element 9: 00

Here also, each sensor element 6 to 9 therefore has an address code which is specific to this sensor element 6 to 9.

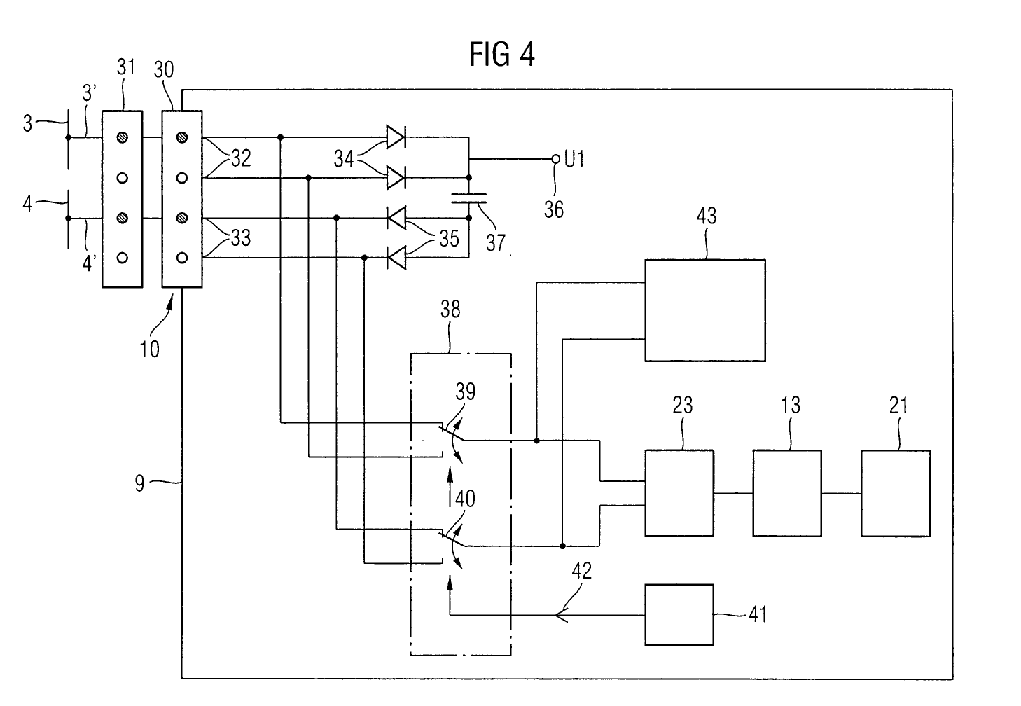

FIG. 4 is a circuit diagram of a sensor element according to the invention for use in a bus system such as depicted in FIG. 3. Because of the assignment of the pins 32, 33, this figure corresponds to sensor element 9 of FIG. 3.

By way of a rectifying element 34, 35, such as a diode, each pin 10 is connected 10 with a terminal 36, which is acted upon by a reference potential U1 (for example, by a supply potential). The rectifying elements 34, 35 are arranged parallel to one another, with the diodes 34 being coupled with the first pins 32 antiparallel to the diodes 35 coupled with the second pins 32, and are connected by way of a coupling capacitor 37.

Similar to the sensor element in FIG. 2, each pin 10 can be connected with a measuring device 23 by way of connection lines. In principle, the measuring circuit 23 can be implemented in a manner equivalent to the measuring circuit 23 illustrated in FIG. 2. An evaluating circuit 13 and a decoding circuit 21 are, in turn, connected to the output side of this measuring circuit 23. A switch device 38 is provided between the measuring circuit 23 and the pins 10. In the present embodiment, the switch device 38 has two controllable switches 39, 40, such as MOSFETs. In this case, the first controllable switch 39 is connected by way of connection lines with the first pins 32, and the second controllable switch 40 is connected by way of connection lines with the second pins 33. By means of the controllable switches 39, 40, in each case, one of the pins 32, 33 can be selected and connected with the measuring circuit 23.

Further, a control unit 41 is provided which generates a control signal 42, by which the control connections of the controllable switches 39, 40 can be controlled in a defined manner. A respective pin 10 can thereby be connected in a targeted fashion with the measuring device 23.

In FIG. 4, the sensor element 9 also has an integrated circuit 43 which contains the actual sensor as well as the interface of the sensor to the bus lines 3, 4.

Determination of the address coding of the sensor element 9 takes place in a manner equivalent to the method described by means of FIGS. 1 and 2. After the application of a supply potential U1 to the terminal 26, the controllable switches 39,40 are controlled by way of a control signal 42 of the control device 41 such that successively all pins 10 are connected with the measuring circuit 23. In this manner, the potentials are measured on all pins 10. That pin 10 which is connected with bus line 3 has the high potential of the bus line 3 relative to the supply potential U1, while the pin 10 that is connected with bus line 4 has the low potential of bus line 4 relative to the supply potential U1. The two other pins 10 not connected with the bus lines 3, 4 have a potential which results only from the supply potential U1. In this manner, it can be determined which pins 10 in the case of the respective sensor element 9 are currently connected with which bus line 3, 4. This is measured by way of the measuring circuit 23, and a logic level is assigned to the measured potentials in the evaluating circuit 13. In the decoder 21, the decoding of the specific address code then takes place from the determined logic levels.

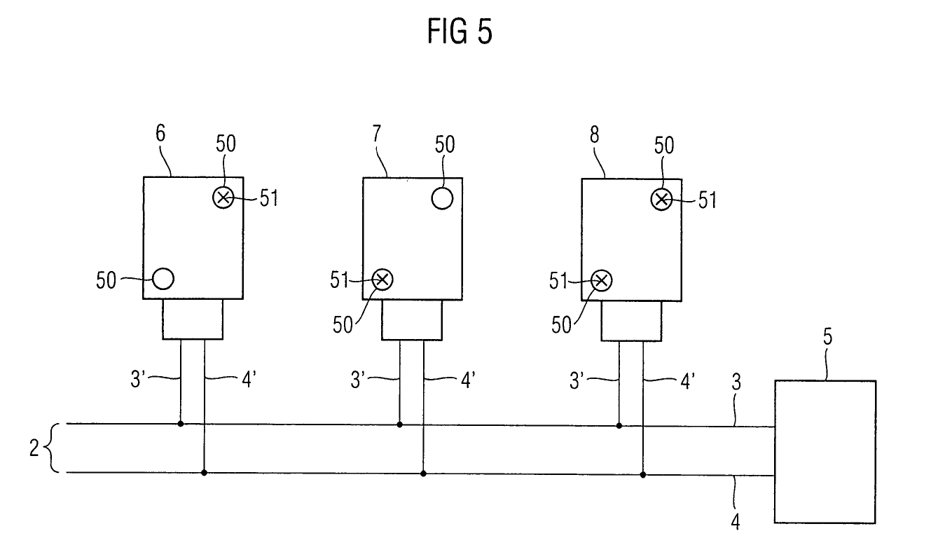

FIG. 5 is a representation of different sensor elements by means of whose screwed connection the position of the respective sensor elements in the motor vehicle can be determined.

FIG. 5 here shows three sensor elements 6 to 8, which have fastening points 50 via which they can be fastened, for example, on a body of a motor vehicle, by way of fastening devices 51, such as screws, rivets, clamps, etc. All sensor elements 6 to 8 here have an identical construction, including exactly two (upper and lower) fastening points 50. During the mounting, different fastening points 50 are used for the various vehicle positions to which the sensor elements 6 to 8 are fastened. For example, sensor element 6 is fastened only by way of the upper fastening point 50; sensor element 7 is fastened only by way of the lower fastening point 50; and sensor element 8 is fastened to both fastening points 50.

Since the vehicle body typically has a ground potential, a fastening point 50 occupied by a fastening device 51 can be electrically determined in a very simple manner. In the present embodiment (three sensor elements 6 to 8), it is sufficient to provide only two fastening points 50. In the case of a larger number of sensor elements 6 to 8, a correspondingly larger number of fastening points 50 must be provided, with the conceivable screwed-connections variants of the fastening devices 51 increasing very rapidly according to the number of fastening points 50.

For detecting which of the fastening points 50 is screwed to a fastening device 51, in principle, a circuit arrangement can be used which corresponds to the one illustrated in FIGS. 2 and 4. By way of these fastening points 50, an addressing can therefore be assigned to the respective sensor element 6 to 8. In this case, it will be assumed that a fastening point occupied by a fastening device 51 indicates a logic “0”, and an unoccupied fastening point indicates a logic “1”. The circuit for determining the address coding is first connected to a bus line 3, 4 with the higher voltage potential, in order to generate a stable “HIGH” signal. For example, this circuit is acted upon by a voltage of over 2 V. The signal generated by the filter of the measuring circuit flows by way of a high-impedance resistor into the address inputs of the evaluating circuit. When the fastening points 50 are not occupied, a voltage of at least 2 V is applied. If a fastening point 50 is connected by way of the fastening device 51 with the vehicle body, the potential applied to this fastening point 50 is pulled toward the reference ground, and thus toward the potential of the vehicle body, so that the potential of the reference ground or a low logic level (LOW) is present at the corresponding address input of the evaluating circuit. In this manner, the decoding of the address code of a sensor element 6 to 8 can be achieved from the occupied and unoccupied fastening points 50.

The invention is therefore particularly suitable in the case of identically constructed sensor elements. Here, a conclusion can be drawn from the signal alone supplied by the sensor, with respect to its position in the motor vehicle. This will be briefly described by means of an example.

Particularly in the case of restraint devices, a plurality of identical sensor elements are installed at various positions in the motor vehicle. For example, there are sensor elements for detecting a lateral impact in a vehicle, so that the corresponding side air bags are triggered. The corresponding sensor elements for the left and right side sections of a motor vehicle in this case have the same effect, and a construction which is as identical as possible. If a sensor signal is transmitted from these sensor elements to the control unit, the control unit can at first not assign the sensor signals to the respective sensor element. In the case of the sensor element according to the invention, an address coding is transmitted simultaneously with the sensor signals, so that the control unit can clearly assign the sensor signals to a respective sensor element. From the address coding, a conclusion can be drawn regarding the side of the motor vehicle at which the crash is taking place; and, as a result, the corresponding air bags situated on this side of the motor vehicle are triggered. The air bags situated on the other side of the motor vehicle do not necessarily have to be triggered and do not have to be triggered at the same speed.

Although the present invention was described above by means of preferred embodiments, it is not limited thereto but can be modified in multiple fashions.

Thus, the invention is not necessarily limited to a bus system constructed as a CAN bus or LIN bus, but can be used in arbitrary bus systems, particularly arbitrary parallel bus systems. The invention is also not necessarily limited to a restraint system in a motor vehicle but can naturally be expanded to arbitrary applications, for example, a comfort system, a pre-crash system, etc.

Although it is assumed in the embodiments that all sensor systems have the same constructions and an identical method of operation, the invention is naturally also suitable in the case of those sensor elements which do not have this characteristic.

Although, in the above-mentioned embodiments, only three or four sensor elements are connected to the bus, the invention is not limited to this number. It is understood that more or fewer sensor elements can be connected to the bus. For this purpose, only a different address coding has to be provided for the respective sensor elements, which can be very easily implemented by providing a higher number of fastening points or output connections.

In addition, the above figures should be understood only in the manner of examples, and should not limit the protective scope of the present invention in this respect.

Also, only an advantageous alignment of the pins was described, which pins naturally may also have different assignments and nevertheless supply a clear address coding.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A sensor element for a bus system in a motor vehicle, comprising:
a first number of pins, by which the sensor element is connectable to the bus lines of the bus system, which bus lines have different potentials; wherein,
the first number is greater than the number of bus lines;
a first device is provided which measures and evaluates the potential on at least one of the pins; and
a second device is provided which assigns to the sensor element a specific address coding from the measured and evaluated potentials.

2. The sensor element according to claim 1, wherein:
the first device has a measuring circuit for measuring the potentials applied to the pin; and
an evaluating circuit for evaluating the measured potentials; and
the evaluating circuit assigns a logical value to a measured potential.

3. The sensor element according to claim 2, wherein the second device has a decoding circuit which is designed for decoding or detecting the address coding assigned to the sensor element by the assignment of the pins.

4. The sensor element according to claim 3, wherein the second device provides means for decoding the signals measured by the first device and the evaluated logical values.

5. The sensor element according to claim 4, wherein the measuring circuit has a low-pass filter with a voltage limiter connected on an output side.

6. The sensor element according to claim 5, wherein:
a sensor circuit is provided which includes a sensor; and
at least one of the first and the second device is a component of the sensor circuit.

7. The sensor element according to claim 6, wherein:
each pin is connected with a single bus line; and
each bus line is connected with at least one pin.

8. The sensor element according to claim 7, wherein:
a first portion of the pins is provided for connecting one respective bus line directly with the sensor element; and
a second portion of the pins is provided for connecting one respective bus line with the sensor element.

9. The sensor element according to claim 5, wherein a controllable switching device is provided, by which the pins of the sensor element are connectable with at least one of the first and second devices, such that only a second number of pins corresponding to the number of bus lines are coupled with at least one of the first and second devices.

10. The sensor element according to claim 9, further comprising a plug which forms a hardware interface to the bus lines, which plug couples the pins of the sensor element with a corresponding jack connected with the bus lines.

11. A bus system in a motor vehicle, having a bus with at least two bus lines, at least one control unit which controls data communication via the bus, and a plurality of sensor elements which are connected by pins to the bus lines; wherein:
a first number of pins of each respective sensor element is larger than a number of bus lines; and
the pins are coupled with the bus lines such that, by assignment of the pins, a clear address coding of each sensor element is obtained.

12. The bus system according to claim 11, wherein:
in each sensor element, a first number of pins corresponding to the number of bus lines is connected with the same bus line; and
remaining pins are differently assigned in the case of all sensor elements.

13. The bus system according to claim 11, wherein:
in all sensor elements, a second number of pins corresponding to the number of bus lines are connected with the bus lines; and
the pins are differently assigned in the case of all sensor elements.

14. The bus system according to claim 13, wherein:
the bus is a two-wire bus which comprises first and second bus lines; and
the first bus line has a high logic level, and the second bus line as a low logic level.

15. The bus system according to claim 14, wherein the bus system comprises a parallel bus system with external sensor elements.

16. The bus system according to claim 15, wherein at least two identical sensor elements are provided.

17. A method of detecting the precise position of identical sensor elements in a bus system having a bus with at least two bus lines, at least one control unit which controls data communication via the bus, and a plurality of sensor elements which are connected by pins to the bus lines; wherein:
each particular sensor element has an assignment of the pins which is specific to that particular sensor element and which defines a binary address coding; and
the precise position of a respective sensor element in the bus system is determined by decoding its binary address coding.

18. The method according to claim 17, wherein the position of the sensor element in the motor vehicle is determined based on the detected position of a sensor element in the bus system.

19. The method according to claim 18, wherein at least one potential is measured which is applied to a pin.

20. The method according to claim 19, wherein for measuring the potential of a pin, the pin is acted upon by a reference potential and is subsequently connected to the measuring circuit.

21. The method according to claim 20, wherein by means of the measured potential, it is determined whether a bus line is currently assigned to a respective pin or which of the bus lines is currently assigned to it.
